(19) United States
(12) Patent Application Publication
(10) Pub. No.: US 2004/0106769 A1
(43) Pub. Date: Jun. 3, 2004

(54) High functional polymers

(76) Inventors: Kevin Brian Hatton, Harlow (GB); Zhi Xin Li, Oxford (GB)

Correspondence Address: PROSKAUER ROSE LLP, PATENT DEPARTMENT, 1585 BROADWAY, NEW YORK, NY, 10036-8299, US

(21) Appl. No.: 10/332,597

(22) PCT Filed: Jul. 6, 2001
(86) PCT No.: PCT/EP01/07804

(30) Foreign Application Priority Data
Jul. 11, 2000 (EP) 00810606.4

(51) Int. Cl. C08G 65/00

(52) U.S. Cl. 528/403; 528/408

(57) ABSTRACT

Compounds of the formula I wherein Q denotes a n-valent aliphatic, cycloaliphatic, aromatic or araliphatic radical, n is a integer from 4 to 512, R₁ is hydrogen or methyl, Y is a radical containing 2 to 30 carbon atoms selected from alkyl, aryl, aralkyl, cycloalkyl, cycloalkylalkyl, alkoxy, aryloxy, aryloxy, cycloalkoxy, cycloalkylalkoxy, —NR₂R₃, —OCOR₂, wherein R₂ and R₃ independently of one another denote alkyl, aryl, aralkyl or cycloalkyl, or Y is a radical of formula II wherein A denotes a m-valent aliphatic, cycloaliphatic, aromatic or araliphatic radical, m is an integer from 2 to 4, have a low viscosity and useful attributes in Adhesive and Tooling materials.

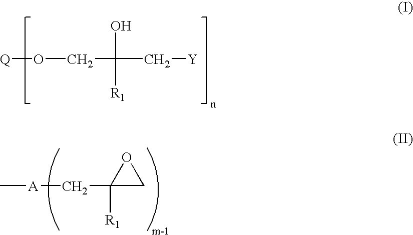

The present invention relates to high functional polymers containing at least four epoxy or hydroxy groups, a process for the preparation of these compounds, curable compositions containing these compounds and the use of the curable compositions.

Densely packed, highly functionalised compounds are of considerable interest for applications in high performance plastics. Attributes of high fracture and impact toughness, high elongation and flexural strength as well as water/chemical resistance are being sought. In the International Application No. PCT/EP 00/05170 a process of reacting multifunctional hydroxy compounds with bis-cycloaliphatic epoxides to produce reaction products containing cycloaliphatic epoxides useful in curable compositions is described. Particular heterogenous catalysts are required to promote the reaction. After reaction the catalyst is removed by filtration.

It has now been found that high functional polymers containing epoxy or hydroxy groups having a low viscosity can be prepared by reaction of monomeric or polymeric compounds having at least four hydroxy groups with mono-, di- or polyfunctional epoxides.

In the present invention, it has been found particularly that an in situ soluble catalyst can be used affording the capability to control, by suitable base inactivation, the amount of reaction promoted. The reaction is particularly suitable for epoxides.

Further, the destroyed catalyst and any minor residual deactivator compound does not inhibit the use of the reaction products in subsequent curable compositions.

Thus the procedure described herein simplifies over the earlier method in that there is no need for filtration. Furthermore there is greater reaction control.

Accordingly, the present invention relates to a compound of the formula I

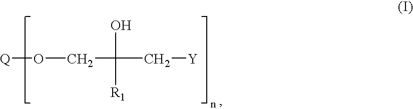

wherein Q denotes a n-valent aliphatic, cycloaliphatic, aromatic or araliphatic radical, n is an integer from 4 to 512,

R₁ is hydrogen or methyl,

Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NRR₃, —OCOR₂, wherein R₂ and R₃ independently of one another denote alkyl, aryl, aralkyl or cycloalkyl, or Y is a radical of formula II

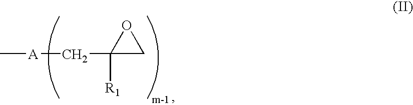

wherein A denotes a m-valent aliphatic, cycloaliphatic,^{(III)} atomatic or araliphatic radical and m is an integer from 2 to 4.

The radical Q is derived from multifunctional alcohols or multifunctional carboxylic acids. Preferred polyols are pentaerythritol, ethoxylated pentaerythritol, propoxylated pentaerythritol, polyglycols obtainable by reaction of pentaerythritol with ethylene oxide, propylene oxide, tetrahydrofuran or ε-caprolactone, dipentaerythritol, ethoxylated dipentaerythritol, propoxylated dipentaerythritol, polyglycols obtainable by reaction of dipentaerythritol with ethylene oxide, propylene oxide, tetrahydrofuran or ε-caprolactone, hydroxyl- or carboxyl-terminated dendritic macromolecules containing a nucleus derived from a monomeric or polymeric compound having at least one reactive hydroxyl, carboxyl or epoxy group per molecule and at least one branching generation derived from a monomeric or polymeric chain extender having at least three reactive sites per molecule selected from hydroxyl and carboxyl groups.

Dendritic macromolecules are well-known, for example from U.S. Pat. Nos. 5,418,301 and 5,663,247, and partly commercially available (e.g. Boltorn® supplied by Perstorp). Hyperbranched and dendritic macromolecules (dendrimers) can generally be described as three dimensional highly branched molecules having a tree-like structure. Dendrimers are highly symmetric, while similar macromolecules designated as hyperbranched may to a certain degree hold an asymmetry, yet maintaining the highly branched tree-like structure. Dendrimers can be said to be monodisperse variations of hyperbranched macromolecules.

Hyperbranched and dendritic macromolecules normally consist of an initiator or nucleus having one or more reactive sites and a number of surrounding branching layers and optionally a layer of chain terminating molecules. The layers are usually called generations, a designation hereinafter used.

In a preferred embodiment, the compounds of the formula I are derived from hydroxyl-terminated dendritic macromolecules containing 8 to 256, in particular 16 to 128, hydroxyl groups per molecule and a molecular weight from 500 to 25000, in particular from 1000 to 20000.

Further preferred compounds of formula I are those wherein Q is the tetravalent residue of pentaerythritol, ethoxylated pentaerythritol, propoxylated pentaerythritol or polyglycols obtainable by reaction of pentaerythritol with ethylene oxide, propylene oxide, tetrahydrofuran or ε-caprolactone.

Moreover, compounds of formula I are preferred wherein R₁ is hydrogen, Y is a radical of formula III wherein R₁ is hydrogen, m is 2 and A is a bivalent radical of the formula IIIa to IIId

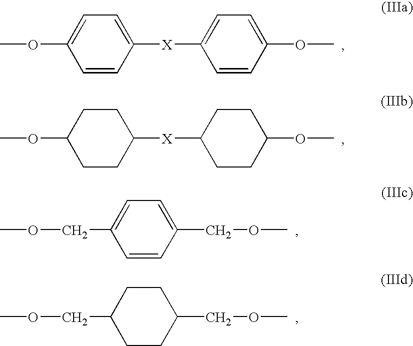

wherein X is a direct bond, methylene, isopropylidene, —CO— or —SO₂—.

Further preferred compounds of formula I are those wherein R₁ is hydrogen, Y is a radical of formula II wherein R₁ is hydrogen, m is 3 or 4 and A is a trivalent radical of the formula IVa or a tetravalent radical of formula IVb

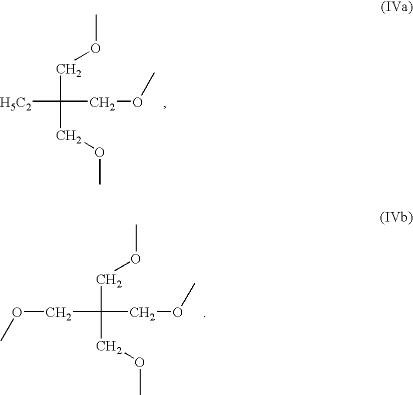

Further preferred compounds of formula I are those wherein Y is a radical of formula V

-Z-(CH₂)ₐ—(CR₄R₅)_{b}—(CH₂)_{c}—CH₃ (V),

wherein Z is oxygen or methylene, R₄ and R₅ independently of one another are hydrogen or C₁-C₁₂alkyl, a is an integer from 0 to 30, b is 0 or 1 and c is an integer from 0 to 30, with the proviso 7≦a+b+c≦30.

In particular, Y is a radical of formula V wherein R₄ and R₅ are hydrogen and 8≦a+b+c≦15.

The reaction of difunctional alcohols with difunctional epoxy compounds using metal triflate catalysts and basic deactivators is described in EP-A 493 916.

Surprisingly we have found that the same synthetic methods can be extended to react multifunctional (>3) alcohols with mono-, di- or multifunctional epoxides to give higher molecular weight, high functionality alcohols or epoxy resins.

There is reported work in the art seeking to achieve highly functional epoxy dendrimeric compounds; these have not been successful.

The present invention has achieved high functionalisation by both a combination of careful control of the reaction conditions and ensuring that the ratio of the starting epoxide to the starting hydroxyl compound is high enough so that gellation does not occur.

Accordingly, the present invention also relates to a process for the preparation of a compound of formula I which comprises reacting a compound Q-(OH)ₙ wherein Q is a n-valent aliphatic, cycloaliphatic, aromatic or araliphatic radical and n is an integer from 4 to 512 with a compound of formula VI

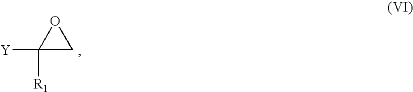

wherein Y and R₁ are as defined above, in the presence of a triflate salt of a metal of Group IIA, IIB, IIIA, IIIB or VIIIA of the Periodic Table of the Elements (according to the IUPAC 1970 convention) and, optionally, deactivating the triflate salt catalyst when the desired amount of modification has been achieved.

Suitable hydroxy compounds Q-(OH)ₙ are basically all monomeric, oligomeric or polymeric compounds containing at least four hydroxy groups per molecule.

Examples are, pentaerythritol, bistrimethylolpropane, diglycerol, dipentaerythritol, 3,3,5,5-tetramethylol-4-hydroxypyran, sugar alcohols, polymers having a molecular weight of at most 8000 obtained by reaction of ethylene oxide, propylene oxide, tetrahydrofuran or ε-caprolactone and one or more of the aforementioned hydroxy compounds.

Hydroxy-terminated dendritic macromolecules are further suitable compounds Q-(OH)ₙ. Dendritic macromolecule can be obtained by reaction of

(A) a central monomeric or polymeric nucleus having at least one reactive hydroxyl, carboxyl or epoxy group per molecule,

(B) at least one branching monomeric or polymeric chain extender having at least three reactive sites per molecule selected from hydroxyl and carboxyl groups, optionally

(C) at least one spacing monomeric or polymeric chain extender having two reactive sites per molecule selected from hydroxyl and carboxyl groups.

Such dendritic macromolecules are described, for example, in U.S. Pat. Nos. 5,418,301 and 5,663,247.

Specific examples of preferred aliphatic multihydroxy compounds Q-(OH)ₙ,(where n>4) include a range of dendritic polyols produced by Perstorp Polyols and sold under the Trade Name Boltorn® Dendritic Polymers. These include Boltorn® H20 (OH functionality=16 and molecular weight=1800) and Boltorn® H30 (OH functionality=32 and molecular weight=3600), Boltorn® H40 (OH functionality=64 and molecular weight=7200) and Boltorn® H50 (OH functionality=128 and molecular weight=14400), as well as such alcohols substituted by alkoxy groups as well as higher polyoxyethylene glycols, poloxypropylene glycols, polyoxytetramethylene glycols and polycaprolactone based on such alcohols.

Suitable epoxy compounds of formula VI are glycidyl esters, glycidyl ethers, N-glycidyl compounds, S-glycidyl compounds as well as the corresponding β-methylglycidyl compounds.

As examples of such resins may be mentioned glycidyl esters obtained by reaction of a compound containing two or more carboxylic acid groups per molecule, with epichlorohydrin or glycerol dichlorohydrin in the presence of an alkali hydroxide.

Such diglycidyl esters may be derived from aliphatic dicarboxylic acids, eg succinic acid, glutaric acid, adipic acid, pimelic acid, suberic acid, azelaic acid and dimerised linoleic acid; from cycloaliphatic dicarboxylic acids such as tetrahydrophthalic acid, 4-methyltetrahydrophthalic acid, hexahydrophthalic acid and 4-methylhexahydrophthalic acid; and from aromatic dicarboxylic acids such as phthalic acid, isophthalic acid and terephthalic acid.

Such triglycidyl esters may be obtained from aliphatic tricarboxylic acids, e.g. aconitic acid and citric acid, from cycloaliphatic tricarboxylic acids such as 1,3,5-cyclohexanetricarboxylic acid and 1,3,5-trimethyl-1,3,5-cyclohexanetricarboxylic acid; and from aromatic tricarboxylic acids such as 1,2,3 benzene tricarboxylic acid, 1,2,4 benzene tricarboxylic acid and 1,3,5 benzene tricarboxylic acid.

Further examples are glycidyl ethers obtained by reaction of a compound containing at least two free alcoholic hydroxy and/or phenolic hydroxyl groups per molecule with epichlorohydrin or glycerol dichlorohydrin under alkaline conditions or, alternatively, in the presence of an acid catalyst and subsequent treatment with alkali. These ethers may be made from acyclic alcohols such as ethylene glycol, diethylene glycol and higher poly(oxyethylene) glycols, propane-1,2-diol and poly(oxypropylene) glycols, propane-1,3-diol, butane-1,4-diol, poly(oxytetramethylene)glycols, pentane-1,5-diol, hexane-2,4,6-triol, glycerol, 1,1,1-trimethylolpropane, pentaerythritol, and sorbitol; from cycloaliphatic alcohols such as resorcitol, quinitol, bis(4-hydroxycyclohexyl) methane, 2,2-bis(4-hydroxycyclohexyl) propane, 1,1-bis(hydroxymethyl)-cyclohex-3-ene, 1,4-cyclohexane dimethanol, and 4,9-bis(hydroxymethyl)tricyclo[5,2,1,0^{2.6}] decane; and from alcohols made from aromatic nuclei, such as N,N-bis(2-hydroxyethyl)aniline and p,p¹-bis(2-hydroxyethylamino)diphenylmethane. Or may be made from mononuclear phenols such as resorcinol and hydroquinone, and from polynuclear phenols such as bis(4-hydroxyphenyl)methane, 4,4′-dihydroxyphenyl sulfone, 1,1,2,2-tetrakis(4-hydroxyphenyl)methane, 2,2-bis (4-hydroxyphenyl)propane, 2,2-bis(3,5-dibromo-4-hydroxyphenyl)propane (tetrabromobisphenol A), and novolaks formed from aldehydes such as formaldehyde, acetaldehyde, chloral and furfuraldehyde, with phenols such as phenol itself, and phenol substituted in the ring by chlorine atoms or by alkyl groups each containing up to nine carbon atoms, such as 4-chlorophenol, 2-methyl phenol and 4-tert-butylphenol.

Di(N-glycidyl) compounds include, for example, those obtained by dehydrochlorination of the reaction products of epichlorohydrin with amines containing at least two amino hydrogen atoms such as aniline, n-butyl amine, bis(4-aminophenyl)methane and bis(4-methylaminophenyl)methane; and N,N′-digylcidyl derivatives of cyclic ureas, such as ethylurea and 1,3-propyleneurea, and hydantoins such as 5,5-dimethylhydantoin.

Examples of di(S-glycidyl) compounds are di-S-glycidyl derivatives of thiols such as ethane-1,2-dithiol and bis(4-mercaptomethylphenyl) ether.

The preparation of polyhydroxy compounds of formula I wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, or —OCOR₂ requires to start from monofunctional epoxides.

Examples of suitable monofunctional epoxides are 1,2-epoxydodecane, 1,2-epoxytetradecane, 1,2-epoxyhexadecane, 1,2-epoxyoctadecane, octyl glycidyl ether, decyl glycidyl ether, dodecyl glycidly ether and tetradecyl glycidyl ether. Mixtures of two or more of the aforementioned epoxides can be applied as well.

The triflate salts disclosed in EP-A 493 916 can also be used as catalyst in the process for the preparation of the compounds of formula I and II according to the present invention. Preferably, the Group IIA metal triflate catalyst is magnesium triflate; the Group IIB metal triflate is preferably zinc or cadmium triflate; the Group IIIA metal triflate catalyst is preferably lanthanum triflate; the Group IIIB metal triflate is preferably aluminium triflate ; and the Group VIIIA triflate catalyst is preferably cobalt triflate.

The amount of the metal triflate catalyst used in the process of the invention ranges from 10 to 500 ppm, especially from 50 to 300 ppm, based on the total weight of the reaction mixture.

Gellation of the reaction mixture should be avoided when epoxy group containing compounds of formula I wherein Y is a radical of formula II are prepared.

The avoidance of gellation requires to employ the starting epoxide and the starting hydroxyl compound in such amounts that a substantial excess of epoxy groups is present. This ratio depends on the starting functionalities of both the hydroxy and epoxy groups present but usually falls in the region of hydroxy: epoxy of between 1:3 and 1:15, especially between 1:4 and 1:12.

When polyhydroxy compounds of formula I free of epoxy groups are prepared, i.e. Y is a radical selected from alkyl, aryl, aralkyl, cycloalkyl, cycloalkylalkyl, alkoxy, aryloxy, aralkoxy, cycloalkoxy, cycloalkylalkoxy, —NR₂R₃, and —OCOR₂, the compound Q-(OH)ₙ and the epoxy group containing compound of formula VI are preferably reacted in such amounts that the ratio of hydroxy groups: epoxy groups is between 10:1 and 1:2, in particular 5:1 and 1:1.

By using suitable monofunctional epoxides and multifunctional alcohols the present invention gives a method of producing mixtures of primary and secondary high functional polyols with control of the amount of modification from 1 to 100%.

The method is self indicating in that when all the monofunctional epoxides have reacted a pronounced red colour is produced within the reaction mixture.

In general it is convenient to employ the metal triflate catalyst in the form of a solution in an organic solvent. Examples of suitable solvents include aromatic hydrocarbon solvents; cycloaliphatic polar solvents such as cycloaliphatic ketones, e.g. cyclohexanone; polar aliphatic solvents such as diols, e.g. diethylene glycol, triethylene glycol, dipropylene glycol, tripropylene glycols as well as using the starting polyol where appropriate.

During the course of the reaction the amount of modification (10-100%) can be followed by measuring the epoxide content of the reaction mixture and the triflate catalyst may be deactivated once the desired amount of modification has been achieved.

As the process of modification proceeds secondary alcohol is generated. Depending on the amount of modification required, especially approaching 100%, the secondary alcohol groups can play a significant part in the reaction process and in some cases the epoxide content can be such that >100% modification can occur. In order to ensure that this process does not continue and lead to gellation (or high viscosity products) the amount of modification should aim not to exceed a maximum of 150% based on the starting alcohol.

Preferably, the triflate salt catalyst is deactivated when 10-100 % of the initial hydroxyl groups of the compound Q-(OH)ₙ has been epoxidised.

The triflate salt catalyst deactivation may be effected e.g. by addition of alkali metal hydroxides or tetraalkylammonium hydroxide salts. Alternatively, the metal triflate salt catalyst used in the process of the present invention can be deactivated by adding a metal complexing agent, e.g. 8-hydroxyquinoline.

The present invention further relates to a curable composition containing

(a) a compound of the formula I or II according to claim 1 wherein Y is a radical of formula II, and

(b) a curing agent for epoxy resins.

Depending on the kind of application, any compound known as curing agent for epoxy resins can be employed as component (b). Suitable curing agents include hardeners which react with epoxy resins at elevated temperatures (heat curing agents) as well as hardeners which are activated by UV irradiation (UV curing agents).

Examples of suitable heat curing agents are carboxylic acids or anhydrides such as phthalic anhydride, tetrahydrophthalic anhydride, methyl tetrahydrophthalic anhydride, 5-methylbicyclo[2,2,1]hept-5-ene-2,3-dicarboxylic acid anydride, pyromellitic dianhydride, trimellitic anhydride, maleic anhydride and dodecenyl succinic anhydride and mixtures thereof; dimer or trimer acids derived from unsaturated fatty acids; Friedel Crafts metal halides, such as aluminium chloride, zinc chloride, boron trifluoride or boron trichloride as well as complexes thereof with ethers, acid anhydrides, ketones and amines; salts such as zinc fluoroborate, magnesium perchlorate and zinc fluorosilicate; aliphatic, aromatic, araliphatic and heterocyclic amino compounds, such as, for example, diethylene triamine, triethylenetetramine, dicyandiamide, melamine, pyridine, benzyldimethylamine, N,N-diethyl-1,3-propanediamine, 4,9-dioxa-1,12-dodecanediamine, dibutylamine, dioctylamine, methylethylamine, pyrrolidine, 2,6-diaminopyridine, 4,4¹-diaminodiphenyl-methane and ring-substituted derivatives thereof, 3,3¹- and 4,4¹-diamino- diphenylsulphone, 1,2-, 1,3- and 1,4-phenylenediamines, 2,4-diamino-toluene and ring alkylated derivatives thereof, diaminostilbene, 2,4,6-tris(dimethylaminomethyl) phenol and soluble adducts of amines and poly epoxides and their salts.

The curing agent component (b) may also be a polyamide containing active amino and/or carboxyl groups, especially one containing a plurality of amino hydrogen atoms and prepared by reacting a polybasic acid with a polyamine.

The curing agent, component (b) may further be a carboxylic acid hydrazide such as stearic acid dihydrazide, oxalic acid dihydrazide, adipic acid dihydrazide, sebacic acid dihydrazide or isophthalic acid dihydrazide; it may also be a 1-cyano-3-alkylguanidine such as 1-cyano-3-methyl guanidine, or the 3,3-dimethyl or 3,3-diethyl derivative; an imidazole such as 2-phenylimidazole, N-methylimidazole or 2-ethyl-4-methyl-imidazole; a salt of a hydroxycarboxylic acid such as lactic acid or salicylic acid, with a tertiary amine such as a Mannich base e.g. 2,4,6-tris(dimethylaminomethyl) phenol; cyanoacetamide; or succinimide.

When the component (a) is a high molecular weight material containing a high ratio of hydroxyl groups to epoxide groups the curing agent, component (b) may be also an aminoplast, a phenol formaldehyde resin or a blocked polyisocyanate, the aminoplast or phenol-formaldehyde resin having at least 2 groups of formula —CH₂OR attached directly to an amidic nitrogen atom or atoms, or directly attached to carbon atoms of a phenolic ring, where R represents a hydrogen atom or an alkyl group from 1 to 6 carbon atoms. Methylolated compounds which can be used include urea-formaldehyde condensates, aminotriazine-formaldehyde condensates, especially melamine-formaldehyde and benzoguanamine-formaldehyde condensates, and phenol-formaldehyde condensates. These may be etheritied if desired, e.g. the n-butyl ethers may be used. Examples of suitable blocked polyisocyanates include di-and polyisocyantaes blocked with caprolactam, an oxime (e.g. cyclohexanone oxime), a monohydric phenol (e.g. phenol itself, p-cresol, p-t-butylphenol), or a monohydric aliphatic, cycloaliphatic or araliphatic alcohol (e.g. methanol, n-butanol, decanol, 1-phenylethanol, 2-ethoxyethanol and 2-n-butoxyethanol). Suitable isocyanates include aromatic diisocyanates such as 1,3-phenylene-, 1,4-naphthylene-, 2,4- and 2,6-tolylene, and 4,4¹-methylenebis (phenylene) diisocyanate, and also their prepolymers with glycols (e.g. ethylene and propylene glycol), glycerol, trimethylolpropane, pentaerythritol, diethyleneglycol, and adducts of alkylene oxides with these aliphatic di-acid polyhydric alcohols.

With respect to the cure of the curable compositions with UV curing agents, any compound that acts as cationic photoinitiator and generates an acid on exposure to actinic irradiation may be used for the preparation of the compositions of the invention. The acid generated may be a so-called Lewis acid or a so-called Broensted acid.

Suitable acid generating compounds include so-called onium salts and iodosyl salts, aromatic diazonium salts, metallocenium salts, o-nitrobenzaldehyde, the polyoxymethylene polymers described in U.S. Pat. No. 3,991,033, the o-nitrocarbinol esters described in U.S. Pat. No. 3,849,137, the o-nitrophenyl acetals, their polyesters, and end-capped derivatives described in U.S. Pat. No. 4,086,210, sulphonate esters of aromatic alcohols containing a carbonyl group in a position alpha or beta to the sulphonate ester group, N-sulphonyloxy derivatives of an aromatic amide or imide, aromatic oxime sulphonates, quinone diazides, and resins containing benzoin groups in the chain, such as those described in U.S. Pat. No. 4,368,253.

Suitable aromatic onium salts include those described U.S. Pat. Nos. 4,058,400 and 4,058,401. Suitable aromatic sulphoxonium salts which can be used include those described in U.S. Pat. Nos. 4,299,938, 4,339,567, 4,383,025 and 4,398,014. Suitable aliphatic and cycloaliphatic sulphoxonium salts include those described in EP-A-0 164 314. Aromatic iodonium salts which can be used include those described in British Patent Specification Nos. 1 516 351 and 1 539 192. Aromatic iodosyl salts which can be used include those described in U.S. Pat. No. 4,518,676.

When the acid generating compound is an aromatic diazonium ion, the aromatic group may be unsubstituted or substituted by one or more arylthio, aryloxy, dialkylamino, nitro, alkyl or alkoxy group.

Examples of metallocenium salts are the compounds of the formula VII

[(R¹)(R²M)ₐ]^{+an}(an/q)[LQₘ]^{-q} (VII)

wherein a is 1 or 2, each of n and q independently of the other is an integer from 1 to 3, M is the cation of a monovalent to trivalent metal from groups IVb to VIIb, VIII or Ib of the Periodic Table, L is a divalent to heptavalent metal or non metal, Q is a halogen atom or one of the groups Q may be a hydroxyl group, m is an integer corresponding to the valency of L+q, R¹ is a π-arene and R² is a π-arene or the anion of a π-arene.

Examples of sulphonate esters of aromatic alcohols containing a carbonyl group in a position alpha or beta to the sulphonate ester group and aromatic N-sulphonyloxyimides are those descried in U.S. Pat. No. 4,618,564, preferably esters of benzoin or α-methylolbenzoin, especially benzoin phenyl sulphonate, benzoin-p-toluene sulphonate and 3-(p-toluenesulphonyloxy)-2-hydroxy-2-phenyl-1-phenyl-1-propanone, and N-sulphonyloxy derivatives of 1,8-naphthalimide, particularly N-benzenesulphonyloxy-and N-(p-dodecylben zenesulphonyloxy)-1,8-naphthalimide.

Examples of aromatic oxime sulphonates are those described in EP-A 0 199 672 or non-reactive derivatives of the reactive oxime sulphonates described in the cited publication. Particularly preferred oxime sulphonates are those of formula VIII

R³—C(R⁴)═N—O—SO₂—R⁵ (VIII),

wherein one of R³ and R⁴ denotes a monovalent aromatic group, especially phenyl or 4-methoxyphenyl, while the other denotes cyano, or R³ and R⁴, together with the carbon atom to which they are attached, form a carbocyclic or heterocyclic group, especially a fluorene or anthrone ring system, and R⁵ denotes an aliphatic, carbocyclic, heterocyclic or araliphatic group, especially 4-tolyl, 4-chlorophenyl or 4-dodecylphenyl.

The oxime sulphonates can be prepared as described in the above-mentioned EP-A-0 199 672. The particularly preferred materials can be prepared by reacting an oxime of formula R³—C(R⁴)═NOH with a sulphonyl chloride of formula R⁵SO₂Cl, usually in an inert organic solvent in the presence of a tertiary amine.

Examples of quinone diazide compounds include o-benzoquinone diazide sulphonyl or o-naphthoquinone diazide sulphonyl esters or amides of compounds, particularly aromatic compounds, having a hydroxy group or amino group respectively. Preferred are o-quinone diazides such as o-benzoquinione diazide sulphonyl and o-naphthoquinone diazide sulphonyl esters of phenols, including monohydric phenols and, particularly, polyhydric phenols such as 2,2-bis(hydroxyphenyl)propanes, dihydroxydiphenyls, di-and tri-hydroxy-substituted benzophenones, and phenolic resins, including phenol-aldehyde resin and polymers of phenols having polymerisable unsaturated substituents.

Examples of o-nitrophenyl acetals are those prepared from an o-nitrobenzaldehyde and a dihydric alcohol, polyesters of such acetals prepared by reaction of the acetals with a polycarboxylic acid or reactive derivative thereof such as an anhydride, and end-capped derivatives of such acetals prepared by reacting the acetals with a carboxylic acid or reactive derivative thereof. Preferred are acetals derived from o-nitrobenzaldehyde and a linear alkylene glycol in which the alkylene group has 4 to 15 carbon atoms which may be interrupted by at least one oxygen atom, or a glycol or a cycloalkylenealkylene glycol, and polyester and end-capped derivatives of such acetals.

Preferred linear glycols from which the acetals may be derived are 1,4-butanediol, 1,5-pentanediol, 1,6-hexanediol, 1,7-heptanediol, diethylene and dipropylene glycols and triethylene and tripropylene glycols. Preferred glycols having a cycloaliphatic ring are 2,2,4,4-tetramethyl-1,3-cyclobutanediol, bis(4-hydroxycyclohexyl)methane, 1,4-cyclohexanediol, 1,2-bis(hydroxymethyl)-cyclohexane and, especially, 1,4-bis(hydroxymethyl)cyclohexane.

Examples of polyesteracetals are those prepared by reaction of the preferred acetals described above with an aromatic dicarboxylic or tricarboxylic acid or anhydride thereof, such as phthalic, terephthalic and trimellitic acids and their anhydrides, and mixtures of two or more thereof. An especially preferred polyesteracetal is that prepared by reacting an acetal derived from o-nitrobenzaldehyde and 1,4-bis(hydroxymethyl)cyclohexane with trimellitic anhydride. Preferred end-capped polyacetals are those prepared by reaction of the preferred acetals described above with monobasic carboxylic acid or reactive derivative thereof, such as acetic and benzoic acids and their chlorides.

The amount of the curing agent component may be varied over a considerable range depending on the curing agent used as is understood by those skilled in the art. Thus, for example, the amine curing agents may be suitably employed in the range of from 1 to 50 parts by weight, per 100 parts by weight of component (a), but where complexes of Friedel Crafts metal halides are used, amounts within the range 0.5 to 10 parts by weight, per 100 parts by weight of component (a) will suffice. Where anhydride curing agents are used, it may be desirable to add a small amount (0.1 to 5 parts by weight, per 100 parts by weight of component (a) of an accelerator such as a tertiary amine, stannous octoate, sulphide or phosphine, to hasten the cure.

The amount of the UV curing agent or cationic photoinitiator may be varied over a range depending on the photoinitiator used as is understood by those skilled in the art and varies from 0.01% to 3%, based on the amount of component (a), or especially 0.1 to 1%. Where such photoinitiators are used, it may be desirable to add a small amount (0.1 to 10 parts by weight, per 100 parts of component (b) of a sensitiser such as isopropyl-9H-thioxanthen-9-one (ITX) to accelerate the cure.

Preferably, the curing agent (b) is a polycarboxylic acid, a polycarboxylic anhydride or an aliphatic, cycloaliphatic, aromatic, araliphatic or heterocyclic amine.

The polyhydroxy compounds of formula I or II free of epoxy groups wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, or —OCOR₂ are suitable polyol components for the preparation of polyurethanes.

Accordingly, the invention further relates to a curable composition containing

(c) a polyisocyanate and

(d) a compound of formula I or II wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, and —OCOR₂ and R₂ and R₃ are as defined above.

The compositions according to the invention are excellently suitable as casting resins, laminating resins, adhesives, compression moulding compounds, coating compounds and encapsulating systems for electrical and electronic components, especially as casting resins and adhesives.

The present invention also relates to the cross-linked products prepared from the compositions according to the invention, such as moulded materials, coatings or bonded materials.

In the examples, which are illustrative of the present invention and are therefore not intended as a limitation on the scope thereof, the following ingredients are used:

| | |
|---|---|
| Boltorn ® H20: | dendritic polyester polyol with theoretically |
| | 16 primary hydroxyl groups per molecule and a |
| | molecular weight of approximately 1800 g/mol |
| | supplied by Perstorp |
| Boltorn ® H30: | dendritic polyester polyol with theoretically |
| | 32 primary hydroxyl groups per molecule and a |
| | molecular weight of approximately 3600 g/mol |
| | supplied by Perstorp |
| Boltorn ® H40: | dendritic polyester polyol with theoretically |
| | 16 primary hydroxyl groups per molecule and a |
| | molecular weight of approximately 7200 g/mol |
| | supplied by Perstorp |
| PEP (426): | pentaerythritol propoxylate with 4 hydroxyl |
| | groups and a molecular weight of 426 g/mol |
| | supplied by Aldrich |
| D-Sorbitol | a sugar alcohol with 6 hydroxyl groups |
| Epoxide 1: | bisphenol A diglycidylether of epoxide |
| | content 5.3 mol/kg supplied by Ciba |
| | Specialty Chemicals PLC |
| Epoxide 2: | modified bisphenol A diglycidylether of |
| | epoxide content 2.8 mol/kg supplied by Ciba |
| | Specialty Chemicals PLC |
| Epoxide 3: | bisphenol F diglycidylether of epoxide |
| | content 6.3 mol/kg |
| Epoxide 4: | cyclohexane dimethanol diglycidylether of |
| | epoxide content 5.8 mol/kg supplied by Ciba |
| | Specialty Chemicals PLC |
| Epoxide 5: | trimethylolpropane triglycidylether of epoxide |
| | content 8.2 mol/kg supplied by Ciba Specialty |
| | Chemicals PLC |
| Epoxide 6: | mixture of n-dodecyl glycidyl ether and |
| | n-tetradecyl glycidyl ether supplied |
| | by Ciba Specialty Chemicals PLC |
| Catalyst C1: | 5% solution of lanthanum trifluoromethanesulphonate |
| | in tripropylene glycol |
| Inhibitor I1: | 2% solution of tetramethyl ammonium hydroxide in |
| | tripropylene glycol. |

### EXAMPLES 1-13

Polyol P1×(g) and Epoxy Resin E1 y (g) are heated together at 110° C. for 30 minutes under vacuum. To this catalyst C1 (0.5 g) was added and the mixture heated for H1 hours at T2° C. until Epoxy Value has dropped to V1 (mol/kg). To this mixture is added Inhibitor I1 (0.5 g) and mixture heated under vacuum for 30 minutes at 80°.

TABLE 1

| | | | | | | T2 | V1 |
|---|---|---|---|---|---|---|---|
| Ex. | P1 | x (g) | E1 | y (g) | H1 (h) | (° C.) | (mol/kg) |
| 1 | Boltorn | 9.0 | epoxide 1 | 91.0 | 4.8 | 160 | 4.1 |
| | H20 | | | | | | |
| 2 | Boltorn | 9.0 | epoxide 1 | 91.0 | 2.3 | 160 | 4.1 |
| | H30 | | | | | | |
| 3 | Boltorn | 5.0 | epoxide 2 | 95.0 | 3.0 | 160 | 2.4 |
| | H20 | | | | | | |
| 4 | PEP (426) | 12.4 | epoxide 1 | 87.6 | 1.0 | 150 | 3.5 |
| 5 | Boltorn | 10.6 | epoxide 3 | 89.4 | 5.0 | 160 | 4.8 |
| | H20 | | | | | | |
| 6 | Boltorn | 9.8 | epoxide 4 | 90.2 | 3.0 | 160 | 4.3 |
| | H20 | | | | | | |
| 7 | Boltorn | 9.8 | epoxide 4 | 90.2 | 3.0 | 160 | 4.4 |
| | H30 | | | | | | |
| 8 | Boltorn | 7.1 | epoxide 5 | 92.9 | 18.0 | 155 | 7.2 |
| | H20 | | | | | | |
| 9 | Boltorn | 7.1 | epoxide 5 | 92.9 | 7.0 | 150 | 7.1 |
| | H30 | | | | | | |
| 10 | Boltorn | 7.1 | epoxide 5 | 92.9 | 8.25 | 150 | 6.7 |
| | H40 | | | | | | |
| 11 | Boltorn | 9.3 | epoxide 5 | 90.7 | 21.5 | 160 | 6.8 |
| | H20 | | | | | | |
| 12 | Boltorn | 13.3 | epoxide 5 | 86.7 | 16.0 | 150 | 5.9 |
| | H20 | | | | | | |
| 13 | D-Sorbitol | 3.9 | epoxide 1 | 96.1 | 6.0 | 150 | 3.7 |

### EXAMPLES 14-16

Polyol P1×(g) and Epoxy Resin E1 y (g) are heated together at 120° C. for 30 minutes under vacuum. To this catalyst C1 (1.0 g) is added and the mixture is heated for H1 hours at T2° C. until reaction mixture has turned red by which time the epoxy value has dropped to 0.0 mol/kg.

TABLE 2

| Ex. | P1 | x (g) | E1 | y (g) | H1 (h) | T2 (° C.) |
|---|---|---|---|---|---|---|
| 14 | Boltorn H20 | 46.1 | epoxide 6 | 53.9 | 10.0 | 175 |
| 15 | Boltorn H20 | 34.4 | epoxide 6 | 65.6 | 4.5 | 180 |
| 16 | Boltorn H30 | 34.4 | epoxide 6 | 65.9 | 3.5 | 180 |

### EXAMPLE 17

Synthesis of a Deuterated Compound of Formula I

1) Deuterated Bisphenol A

A mixture of 25.6 g (0.4 mol) of deuterated acetone, 112.8 g (1.2 mol) of phenol and 24 ml of concentrated hydrochloride acid is saturated with dry hydrogen chloride gas twice a day over a week. The solid reaction mixture is broken up in hot water and excess phenol is removed by vacuum distillation. The white needle crystals are obtained after twice recrystallization from toluene. The product has the melting point 151° C.

2) Deuterated Diglycidyl Ether of Bisphenol A

A three-neck flask is fitted with a mechanical stirrer, a thermometer and dropping funnel. 35 g (0.15 mol) of deuterated bisphenol A and 139 g(1.5 mol) epichlorohydrin are added and heated to 119° C. under stirring. 30 g of 40% aqueous sodium hydroxide (0.3 mol) are added to the boiling reaction mixture during 4 hours period. The excess of epichlorohydrin is distilled off. Toluene is added with stirring and the salt is filtered. Additional toluene is used to wash the solid salt. The toluene is distilled off and the product DGEBA is dried under vacuum at 40-50° C. An epoxy value of 5.1 epoxy equivalents/kg is obtained (molecular weight different has been account in).

Other forms of partially or fully deuterated DGEBA can be obtained by choosing either deuterated or protonated ketone, phenol and epichlorohydrin.

3) Deuterated Dendritic Macromolecules Containing Epoxy Groups

A three-neck flask is fitted with a mechanical stirrer, a thermometer and a vacuum line. Stirring is kept through the whole reaction. A mixture of 4.5 g Boltorn H20 and 45 g of deuterated DGEBA is dried at 110° C. for half hour under vacuum. 0.5 ml 5% lanthanum triflate in tripropylene glycol is added and the mixture is heated at 160° C. for 3 hours under vacuum. 0.5 ml of tetramethylammonium hydroxide in tripropylene glycol is added as deactivator of the catalyst after the mixture has cooled to 100° C. The temperature is kept at 80° C. for a further half hour. An epoxy value of 3.9 epoxy equivalents/kg is obtained.

### EXAMPLE 18

Application Example—Adhesive Composition

Adhesive composition are prepared by mixing the epoxy resins and amines given in Table 3 stoichiometrically at room temperature along with Ballotini to act as a 0.1 mm spacer. The adhesive is applied to two 114×25×1.6 mm degreased, chromic acid treated L165 aluminum pieces which are clamped together to form a joint of 25×12.5 mm. After curing in an oven for 2 h at 60° C. the lap-shear joint is pulled apart a 10 mm/min in triplicate at 25° C. As can be seen from Table 3, much higher lap shear strengths are obtained from the compositions according to the invention.

TABLE 3

| Epoxy Resin | Amine | Lap-shear Strength (N/mm²) |
|---|---|---|
| Example 1 Product | DETA | 26 |
| Example 1 Product | TTDA | 38 |
| Epoxide 1 (comparison) | DETA | 17 |
| Epoxide 1 (comparison) | TTDA | 28 |

DETA: Diethylenetriamine supplied by Aldrich Chemicals
TTDA: 4,7,10-Trioxa-1,13-tridecanediamine supplied by Aldrich Chemicals

### EXAMPLE 19

Synthesis of a Polyurethane

A curable composition is prepared from

| | |
|---|---|
| 69.9 g | Example 16 Product |
| 29.4 g | Tolonate HDT LV (hexamethylene diisocyanate trimer |
| | supplied by Rhodia) |
| 0.7 g | DBTL (Dibutyl tin dilaurate supplied by Aldrich Chemicals) |

Polyol, Isocyanate and catalyst are mixed by hand at room temperature and then poured into a rubber mould. After 10 minutes the sample has cured enough to enable it to be removed from the mould. The moulded object is then placed in an oven at 60° C. for 1 hour to give on cooling to room temperature a rubbery solid.

1. A compound of the formula I 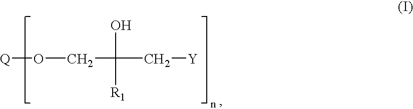
wherein Q denotes a n-valent aliphatic, cycloaliphatic, aromatic or araliphatic radical, n is an integer from 4 to 512,
R₁ is hydrogen or methyl,
Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, —OCOR₂, wherein R₂ and R₃ independently of one another denote alkyl, aryl, aralkyl or cycloalkyl, or Y is a radical of formula II 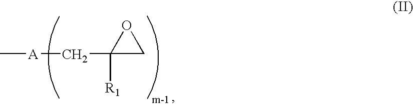
wherein A denotes a m-valent aliphatic, cycloaliphatic, aromatic or araliphatic radical, m is an integer from 2 to 4.

2. A compound of formula I according to claim 1 wherein Q is the tetravalent residue, after removal of the hydroxyl groups, of pentaerythritol, ethoxylated pentaerythritol, propoxylated pentaerythritol, a polyglycol obtainable by reaction of pentaerythritol with ethylene oxide, propylene oxide, tetrahydrofuran or ε-caprolactone, or Q is the hexavalent residue, after removal of the hydroxyl groups, of dipentaerythritol, ethoxylated dipentaerythritol, propoxylated dipentaerythritol, a polyglycol obtainable by reaction of dipentaerythritol with ethylene oxide, propylene oxide, tetrahydrofuran or ε-caprolactone, or Q is the residue of a hydroxyl- or carboxyl-terminated dendritic macromolecule containing a nucleus derived from a monomeric or polymeric compound having at least one reactive hydroxyl, carboxyl or epoxy group per molecule and at least one branching generation derived from a monomeric or polymeric chain extender having at least three reactive sites per molecule selected from hydroxyl and carboxyl groups.

3. A compound of formula I according to claim 1 wherein Q is the residue of a hydroxyl-terminated dendritic macromolecule containing 8 to 256 hydroxyl groups per molecule and a molecular weight from 500 to 25000.

4. A compound of formula I according to claim 1 wherein Q is the tetravalent residue of pentaerythritol, ethoxylated pentaerythritol, propoxylated pentaerythritol or a polyglycol obtainable by reaction of pentaerythritol with ethylene oxide, propylene oxide, tetrahydrofuran or ε-caprolactone.

5. A compound of formula I according to claim 1 wherein R₁ is hydrogen, Y is a radical of formula III wherein R₁ is hydrogen, m is 2 and A is a bivalent radical of the formula IIIa to IIId 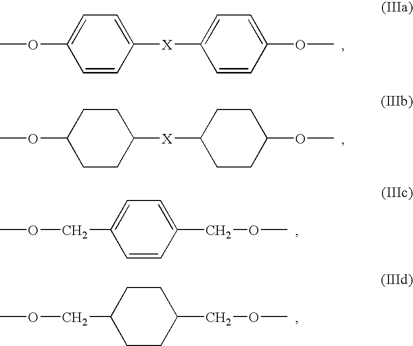
wherein X is a direct bond, methylene, isopropylidene, —CO— or —SO₂—.

6. A compound of formula I according to claim 1 wherein R₁ is hydrogen, Y is a radical of formula II wherein R₁ is hydrogen, m is 3 or 4 and A is a trivalent radical of the formula IVa or a tetravalent radical of formula IVb

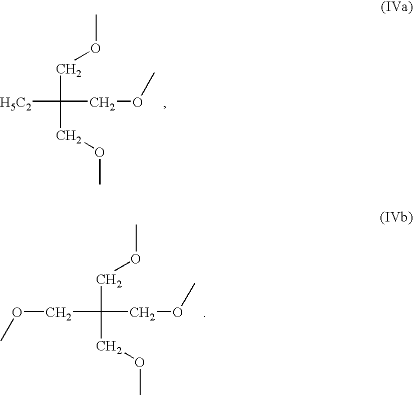

7. A compound of formula I according to claim 1 wherein Y is a radical of formula V
-Z-(CH₂)ₐ—(CR₄R₅)_{b}—(CH₂)_{c}—CH₃ (V),
wherein Z is oxygen or methylene, R₄ and R₅ independently of one another are hydrogen or C₁-C₁₂alkyl, a is an integer from 0 to 30, b is 0 or 1 and c is an integer from 0 to 30, with the proviso 7≦a+b+c≦30.

8. A compound of formula I according to claim 1 wherein Y is a radical of formula V according to claim 7, wherein R₄ and R₅ are hydrogen and 8≦a+b+c≦15.

9. A process for the preparation of a compound of formula I according to claim 1 which comprises reacting a compound Q-(OH)ₙ wherein Q is a n-valent aliphatic, cycloaliphatic, aromatic or araliphatic radical and n is an integer from 4 to 512 with a compound of formula VI 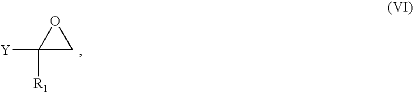
wherein Y and R₁ are as defined in claim 1, in the presence of a triflate salt of a metal of Group IIA, IIB, IIIA, IIIB or VIIIA of the Periodic Table of the Elements (according to the IUPAC 1970 convention) and, optionally, deactivating the triflate salt catalyst when the desired amount of modification has been achieved.

10. A process according to claim 9 in which the deactivation of the triflate salt catalyst is effected by adding an alkali metal hydroxide or a metal complexing agent.

11. A process according to claim 9 in which the amount of the triflate salt catalyst ranges from 10 to 500 ppm, based on the total composition.

12. A process according to claim 9 for the preparation of a compound of formula I or II according to claim 1 wherein Y is a radical of formula II which comprises employing the hydroxy compound Q-(OH)ₙ and the epoxy compound of formula VI in such amounts that the ratio of hydroxy groups : epoxy groups is between 1:3 and 1:15.

13. A process according to claim 9 for the preparation of a compound of formula I according to claim 1 wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, and —OCOR₂, which comprises reacting a compound Q-(OH)ₙ with a compound of formula VI wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃ and —OCOR₂ in such amounts that the ratio of hydroxy groups: epoxy groups is between 10:1 and 1:2.

14. A process according to claim 9 wherein the triflate salt catalyst is deactivated when 10-100% of the initial hydroxyl groups of the compound Q-(OH)ₙ have been epoxidised.

15. A curable composition containing
(a) a compound of the formula I or II according to claim 1 wherein Y is a radical of formula II and
(b) a curing agent for epoxy resins.

16. A curable composition according to claim 15 in which the curing agent (b) is a polycarboxylic acid, a polycarboxylic anhydride or an aliphatic, cycloaliphatic, aromatic, araliphatic or heterocyclic amine.

17. A curable composition containing
(c) a polyisocyanate
(d) a compound of formula I or II according to claim 1 wherein Y is a radical containing 2 to 30 carbon atoms selected from alkyl, aryl, aralkyl, cycloalkyl, cycloalkylalkyl, alkoxy, aryloxy, aralkoxy, cycloalkoxy, cycloalkylalkoxy, —NR₂R₃, and —OCOR₂ and R₂ and R₃ are as defined in claim 1.

18. A crosslinked product obtainable by curing a composition according to claim 16 or 17.

19. The use of a composition according to claim 16 or 17 as adhesive or casting resin.
